(19) United States
(12) Patent Application Publication
(10) Pub. No.: US 2006/0003297 A1
(43) Pub. Date: Jan. 5, 2006

(54) Language disorder assessment and associated methods

(76) Inventors: Elisabeth Wiig, Arlington, TX (US); Patricia Jean Zureich, San Antonio, TX (US); Wayne A. Secord, Orlando, FL (US)

Correspondence Address: JACQUELINE E. HARTT, PH.D;ALLEN, DYER, DOPPELT, MILBRATH & GILCHRIST, P.A., P.O. BOX 3791, ORLANDO, FL, 32802-3791, US

(21) Appl. No.: 11/154,280

(22) Filed: Jun. 16, 2005

Related U.S. Application Data
(60) Provisional application No. 60/580,210, filed on Jun. 16, 2004.

(51) Int. Cl. G09B 19/00

(52) U.S. Cl. 434/236

(57) ABSTRACT

A language assessment includes an ability to pursue a nonlinear process model. A multi-stage suite of subtests is provided, each stage comprising a plurality of subtests designed to evaluate a particular level of language disorder. The suite can be entered and left at any point depending upon prior knowledge and assessment results. Subtests are included for evaluating phonological awareness, word meanings and vocabulary (semantics), word and sentence structure (syntax and morphology), the rules of oral language used in responding to and conveying messages (pragmatics), and recall and retrieval of spoken language (memory). The results of the assessment are presented in a report, in which educationally relevant recommendations are made for intervention and accommodations. An observational rating scale for authentic evaluation of communication in academic settings and a pragmatics profile for assessing social language skills in different contexts are provided.

### CROSS-REFERENCE TO RELATED APPLICATION

This application claims priority to Provisional Application Ser. No. 60/580,210, filed on Jun. 16, 2004, entitled “Language Disorder Assessment and Associated Methods,” the disclosure of which is incorporated hereinto.

### BACKGROUND OF THE INVENTION

1. Field of the Invention

The present invention relates to systems and methods for testing for language disorders, and, more particularly, to such systems and methods that are dynamic and efficient.

2. Description of Related Art

A previously used language assessment tool, the Clinical Evaluation of Language Fundamentals—Third Edition, was published in 1995, and is commonly owned with the present application. The model for this assessment is linear, that is, the assessment is given in its entirety, and scores are used to prepare a report from the entire assessment.

It would be useful to be able to administer such an evaluation dynamically, entering and leaving at various points in the assessment, in order to provide a more efficient instrument.

Previously known assessments are also known to have an environment that is strictly evaluation-situational. It would be useful to include a contextual element in such an assessment that would provide a pragmatic component to the assessment.

It would also be valuable to provide a computerized scoring capability.

### SUMMARY OF THE INVENTION

The present invention is directed to a language assessment that includes an ability to pursue a nonlinear process model. A multi-stage suite of subtests is provided, each stage comprising a plurality of subtests designed to evaluate a particular level of language disorder. The suite can be entered and left at any point depending upon prior knowledge and assessment results. A plurality of the subtests are newly added to the present edition, including subtests for evaluating phonological awareness, word meanings and vocabulary (semantics), word and sentence structure (syntax and morphology), the rules of oral language used in responding to and conveying messages (pragmatics), and recall and retrieval of spoken language (memory).

The assessment has been designed to respond to diverse populations and to minimize bias. Further, the assessment has been expanded to include descriptive, authentic evaluation of communication skills.

The results of the assessment are presented in a report, which in some embodiments can be prepared automatically with the use of a computer software package, in which educationally relevant recommendations are made for intervention and accommodations. Newly provided are an observational rating scale for authentic evaluation of communication in academic settings and a pragmatics profile for assessing social language skills in different contexts.

The present edition of the assessment is easier to score, making interpretation of the results quicker.

Further, the assessment of the present invention is designed to enable clinicians to respond better to state regulations and the Individuals with Disabilities Education Act (IDEA) Amendment of 1977 (Public Law 105-17) and evaluate a child's strengths and communication needs, parental concerns, and the possible need for assistive technology to develop an Individualized Education Program (IEP). The assessment more closely resembles the steps of the clinical decision-making process: making a diagnosis, determining eligibility, identifying strengths and weaknesses, recommending classroom language adaptations and accommodations, planning curriculum-relevant intervention, and measuring treatment efficacy.

The features that characterize the invention, both as to organization and method of operation, together with further objects and advantages thereof, will be better understood from the following description used in conjunction with the accompanying drawing. It is to be expressly understood that the drawing is for the purpose of illustration and description and is not intended as a definition of the limits of the invention. These and other objects attained, and advantages offered, by the present invention will become more fully apparent as the description that now follows is read in conjunction with the accompanying drawing.

### BRIEF DESCRIPTION OF THE DRAWINGS

FIG. 1 is a flow chart for the linear model of the assessment.

FIG. 2 is a schematic illustration of the nonlinear model of the assessment.

FIG. 3 is a chart of the subtests included in a preferred embodiment of the assessment.

FIG. 4 is a chart of subtests to be administered in age-specific categories.

FIGS. 5A-5L is an exemplary four-level summary report.

### DETAILED DESCRIPTION OF THE PREFERRED EMBODIMENTS

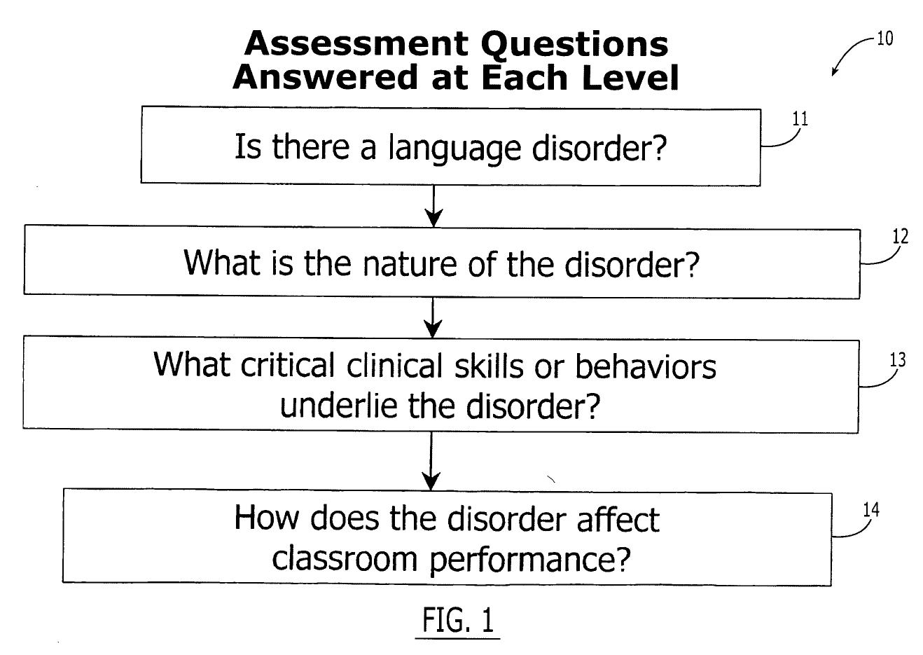

A description of the preferred embodiments of the present invention will now be presented with reference to FIGS. 1-5L.

The assessment and associate methods for evaluating language fundamentals includes a multiperspective, multilevel model that can be delivered in linear or nonlinear fashion, and is more flexible than previously known assessments. In the linear model 10 (FIG. 1), level 1 11 identifies whether or not a language disorder is present; level 2 12, strengths and weaknesses (e.g., determines the nature of the disorder); level 3 13, the underlying clinical skills or behaviors that may contribute to the disorder (e.g., determines the presence of auditory processing, memory storage and retrieval, and/or phonological awareness problems); and level 4 14, language and communication disorders in context (e.g., home or classroom).

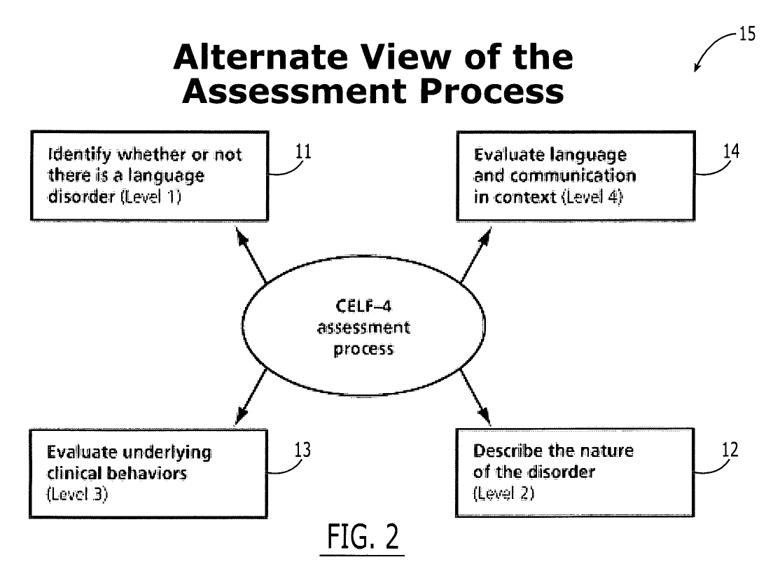

In the nonlinear model 15 (FIG. 2), the four levels can be administered in any desired order, with some levels skipped if desired. For example, if it is already known that a language disorder exists, level 1 11 is not administered. Similarly, if the nature of the disorder is already known, level 2 12 is not administered. In addition, the administration can be halted at any point in the process. For example, age-specific start points and performance-based discontinue rules across selected subtests are provided in the preferred embodiment.

In a particular embodiment, the examiner can determine at what level to begin testing. If the student is a new referral, for example, the examiner may begin at level 1, administering subtests to obtain a core language score. If the referral indicates that the student has problems in the classroom, testing could begin at level 4, where the classroom teacher and/or a parent can provide information relating to language behaviors in situ.

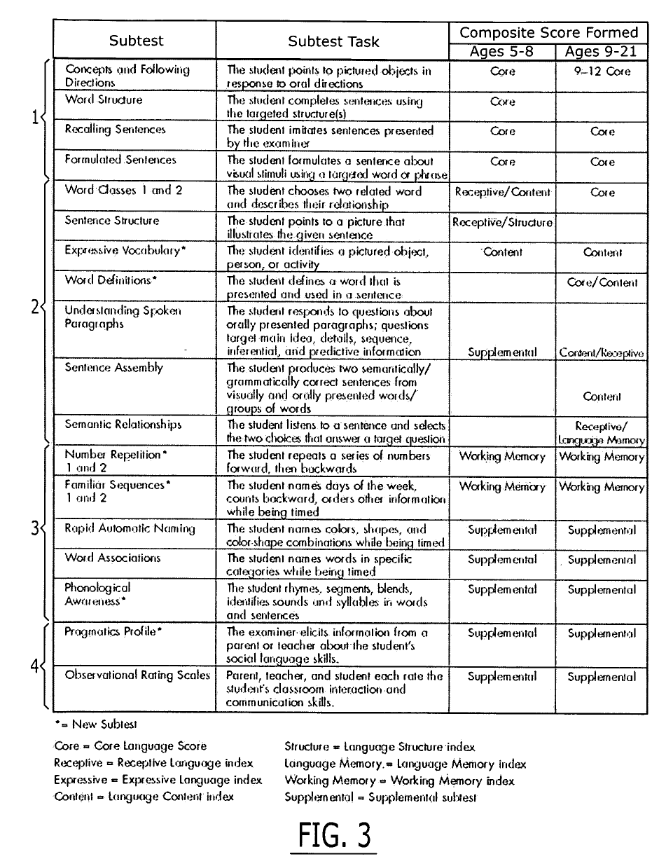

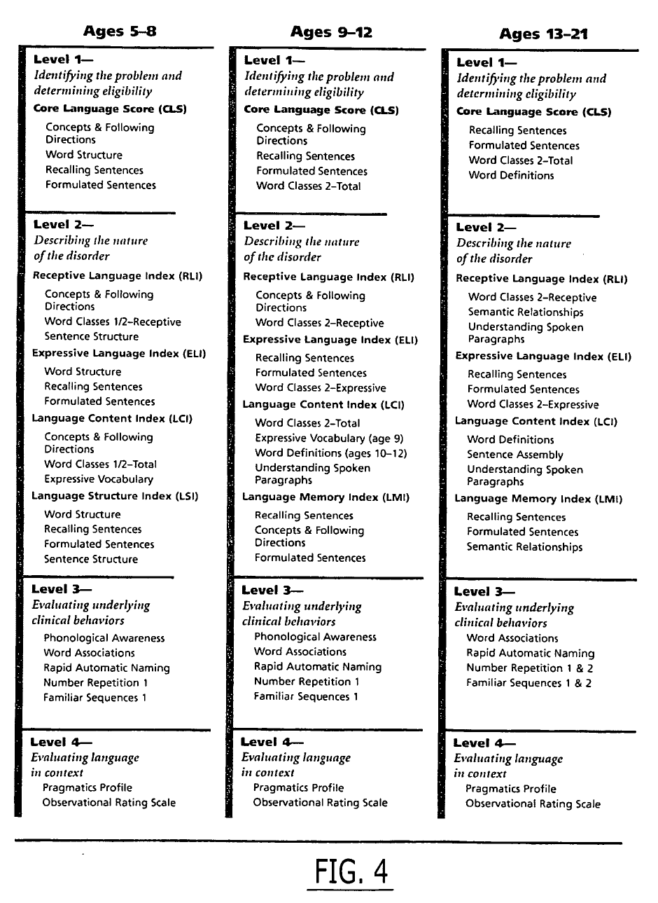

An administration of level 1 efficiently determines if the student has a language disorder and is eligible for services. In a preferred embodiment, four core subtests are administered, including (FIGS. 3 and 4):
1. Concepts and following directions, wherein the student points to pictured objects in response to oral directions
2. Word structure, wherein the student completes sentences using the targeted structure(s)
3. Recalling sentences, wherein the student imitates sentences presented by the examiner
4. Formulated sentences, wherein the student formulates a sentence about visual stimuli using a targeted word or phrase.

The core subtests can be given in 30-45 minutes.

In level 2, modality or content strengths and weaknesses are delineated, determining the nature of a disorder. New subtests in this level, which probe vocabulary skills, include:
1. Expressive vocabulary, wherein the student names illustrations of people, objects, and actions (referential naming). In particular, this ability relates to preschool and elementary grade curriculum objectives for labeling and remembering names for people and objects (nouns) and actions (verbs) and using them in academic contexts in response to pictures, graphs, diagrams, and other illustrations, and in spontaneous language to express concise meaning.
2. Word definitions, wherein the student's ability to analyze words for their meaning features is evaluated. The student is also asked to define words by referring to class relationships and shared meanings, and to describe meanings that are unique to the reference or instance. This ability typically relates to upper elementary and secondary grade curriculum objectives for knowing and using words as concepts with broad, generic applications, rather than with narrow, concrete, and contextually bound meanings.

In level 3, underlying clinical behaviors are evaluated. Newly added subtests at this level include:
1 and 2. Familiar sequences and number repetition, which assess working memory and the possible effect memory skills may have on a student's language disorder. The results of these subtests can provide a preliminary screening tool to be used in making decisions about the need for referrals to other professionals who can fully evaluate the student's memory abilities.

3. Phonological awareness evaluates the student's knowledge of the sound structure of language and the ability to manipulate sound through (a) rhyme awareness and production; (b) sentence, syllable, and phoneme segmentation; (c) syllable and phoneme blending; (d) syllable detection; and (e) phoneme identification and manipulation. Phonological awareness skills typically relate to preschool and elementary-grade curriculum objectives for producing rhyme and manipulating sounds required for pre-reading and reading. This subtest strengthens the assessment's ties to literacy.

In level 4, authentic and descriptive measures of performance are provided for classroom accommodations, adaptations, and enhancements. Two new subtests are included here:
1. Pragmatics profile, wherein the examiner elicits information from a parent or teacher about the student's social language skills. Descriptive items in three areas are probed: rituals and conversational skills; asking for, giving, and responding to information; and nonverbal communication skills. This subtest broadens the scope of assessment by encouraging teachers and/or caregivers to participate in the evaluation process, assisting in the evaluation of a child's language use.

The pragmatics profile addresses speech intentions that are expected for social and school interactions in mainstream classrooms. Pragmatics deficits, in which verbal and/or nonverbal aspects of communication in context are affected, are not unique to children, adolescents, and young adults with language disorders. They also occur in students with developmental learning disabilities and executive function disorders. Because social contexts impose fewer constraints on the communicator than academic contexts, some students with language disorders may not show significant deficits when communicating in social contexts. In academic contexts, required pragmatic repertories include asking for, giving, and responding to information and expressing intentions that can be complex in content and structure. Participation in classroom discussions or group projects requires complex, verbal pragmatic forms such as persuasion and negotiation skills. In contrast, social conversation is less complex in content and structure, and often the student with a language disorder can control topics, ideas, and levels of complexity.

The pragmatics profile can be used to identify students who demonstrate verbal or nonverbal pragmatic deficits that may negatively influence social and academic communication in context. The profile can be completed after a student has been diagnosed with a language disorder to determine the presence and extent of verbal or nonverbal communication difficulties in context. The pragmatics profile can also be used with a student who has not been identified as having a disorder to obtain information for referral for additional testing and for planning appropriate intervention.
2. Observational rating scale is a performance-based assessment that includes statements that describe problems a student may have in listening, speaking, reading, and writing. Parents and teachers rate the student using a 4-point frequency of occurrence scale. The student can also evaluate his or her own skills in this area. This subtest provides information about the student's language in classroom and home contexts.

Difficulties in communication and language can directly affect: (1) content-area learning, what students want to learn, and the materials and mechanisms through which that is accomplished; (2) the learning process itself—the activities that help students gain key skills and strategies and make sense out of essential ideas and information; and (3) classwork and assignments—vehicles through which students demonstrate what they have learned.

The observational rating scale measures the student's ability to meet and to manage school curriculum objectives for following teacher instructions, and the manage classroom behaviors and interactions. It can be used with students who may not be able to participate fully in the school curriculum, when there is a concern about a student's language performance within the classroom, or when there is a need to identify situations or contexts in which reduced language performance occurs.

The results of the assessment of the present invention provide a comprehensive look at a student's language ability, from which can be determined the most appropriate evaluation procedures from an array of assessment options. In addition to subtest scaled scores, the assessment provides a core language score (level 1) and composite index scores.

Different combinations of subtests form the core language score and the index scores, which provide information about a student's strengths and weaknesses across receptive and expressive modalities, language content, language structure, and the application of working memory to linguistic content and structure. The scores and indexes provided by the assessment of the present invention include:
1. Core language score, a measure of general language ability that quantifies a student's overall language performance and can be used to make decisions about the presence or absence of a language disorder. The core language score is derived in a preferred embodiment by summing the scaled scores from the subtests that best discriminate typical language performance from disordered language performance.
2. Receptive language index, a measure of listening and auditory comprehension, is derived in a preferred embodiment by summing the scaled scores from a combination of a plurality of receptive subtests. The subtests used to derive this index preferably depend upon the student's age.
3. Expressive language index, an overall measure of expressive language skills. The subtests used to derive this index also preferably depend upon the student's age.
4. Language content index, a measure of various aspects of semantic development, including vocabulary, concept and category development, comprehension of associations and relationships among words, interpretation of factual and inferential information presented orally, and the ability to create meaningful, semantically and syntactically correct sentences.
5. Language structure index, an overall measure of receptive and expressive components of interpreting and producing sentence structure, preferably used for students 5-8 years of age.
6. Language memory index, a measure of the ability to recall spoken directions, formulate sentences with given words, and identify semantic relationships, and of the ability to apply working memory to linguistic content and structure, preferably used for students 9-21 years of age.
7. Working memory index, a measure of attention, concentration, and recall. This complex manipulation of stimuli in short-term memory underlies the concept of working memory.

A software package is also provided as part of the present invention for automatically calculating scores and providing scoring summaries and narrative reports of student performance. The software package also provides recommendations for treatment and/or therapy and classroom accommodations. The software package may be interactive with the examiner, permitting a “manual” selection from among a plurality of recommendations, and can also add recommendations of his/her own. These added recommendations can also be retained so as to be accessible to the software package in future by the examiner.

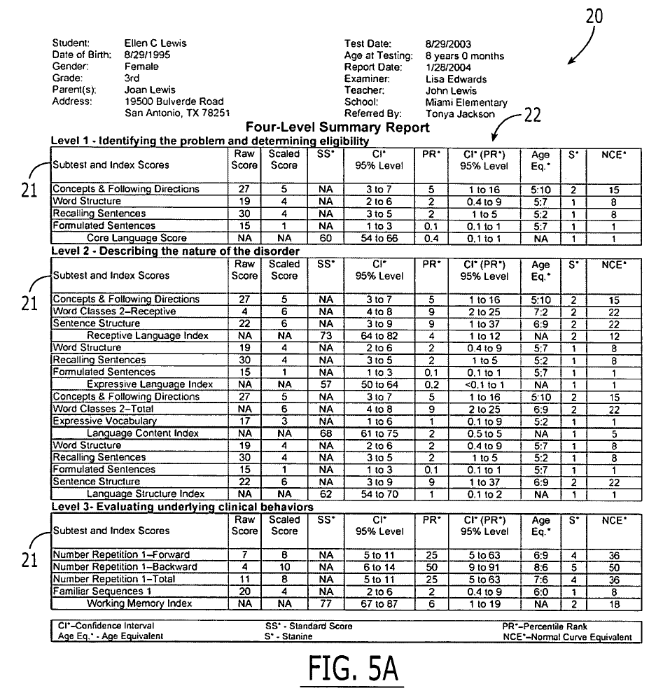

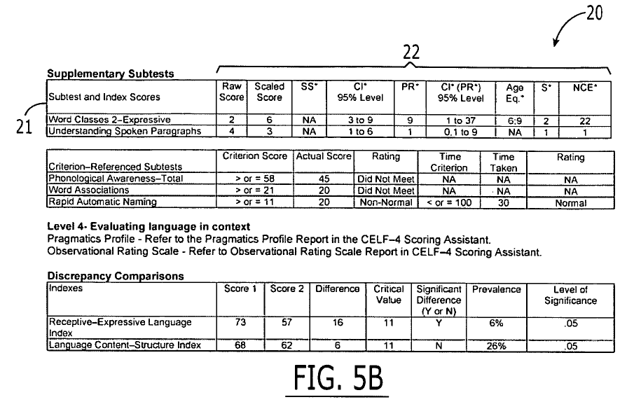

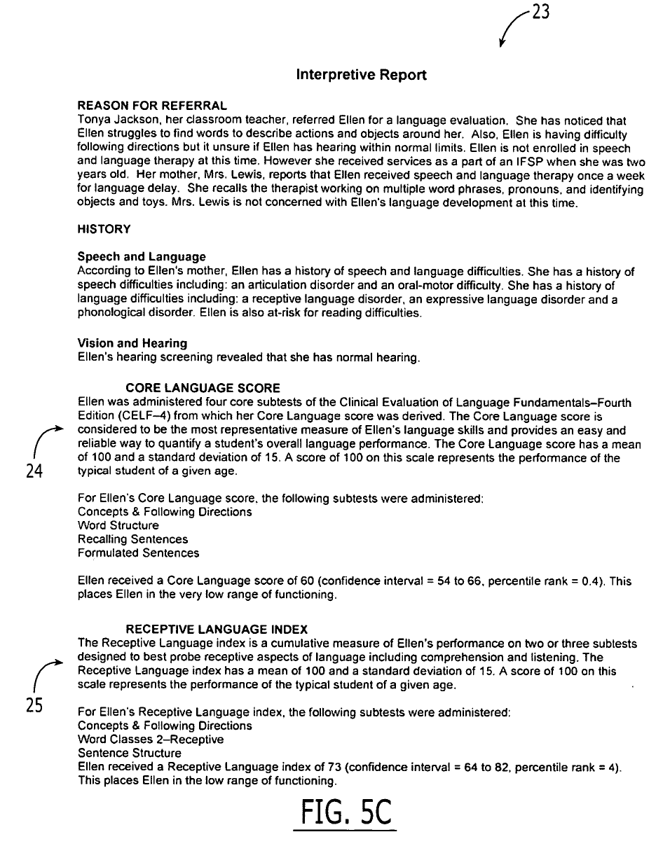

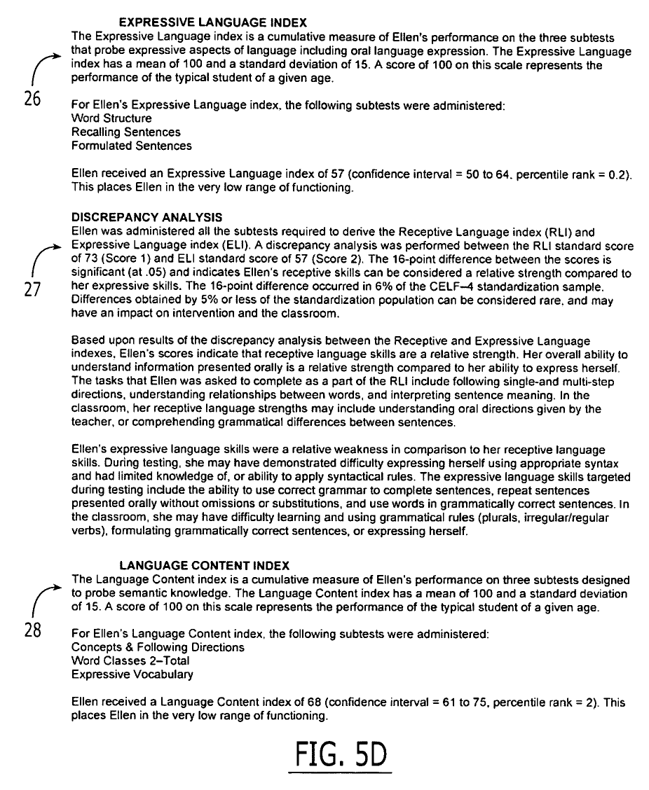

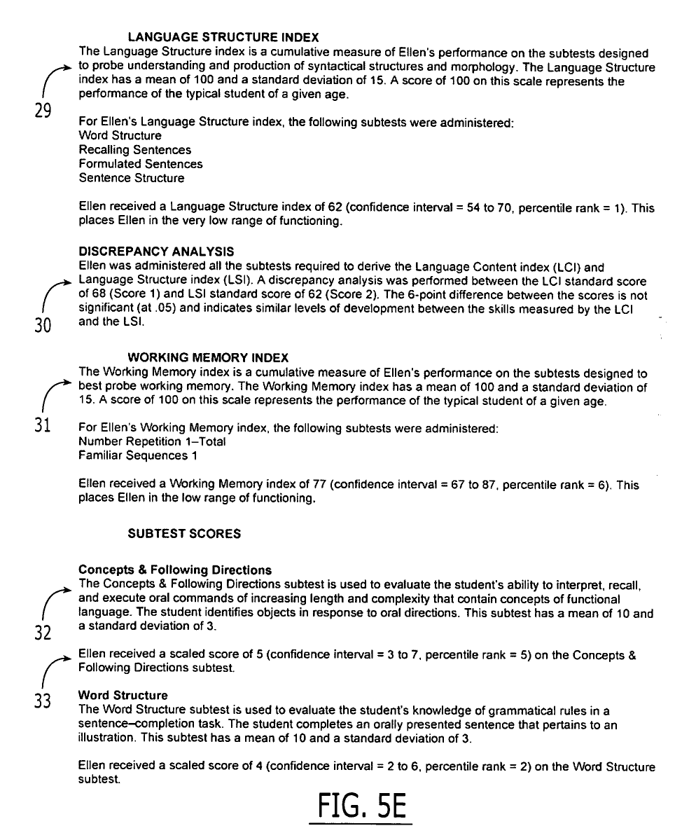

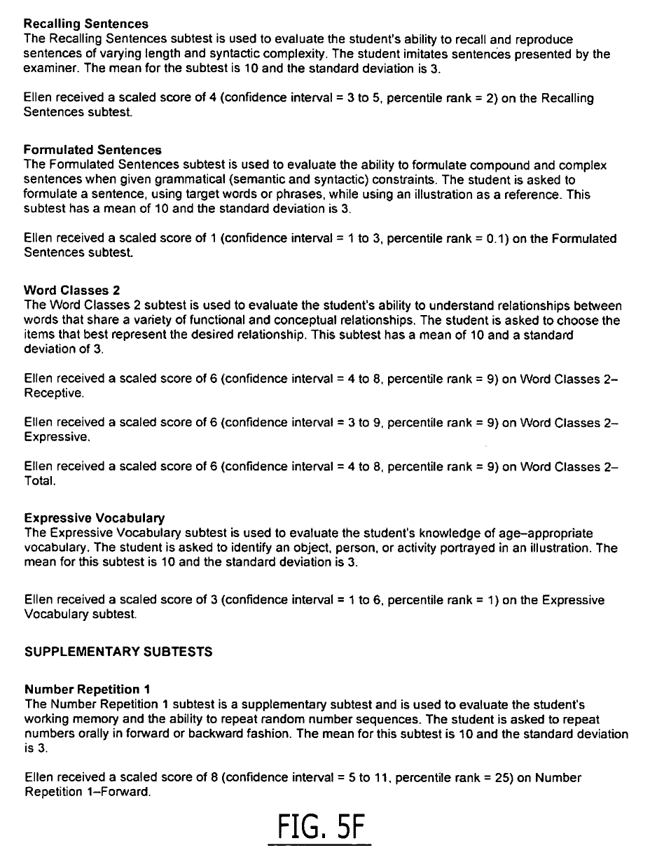

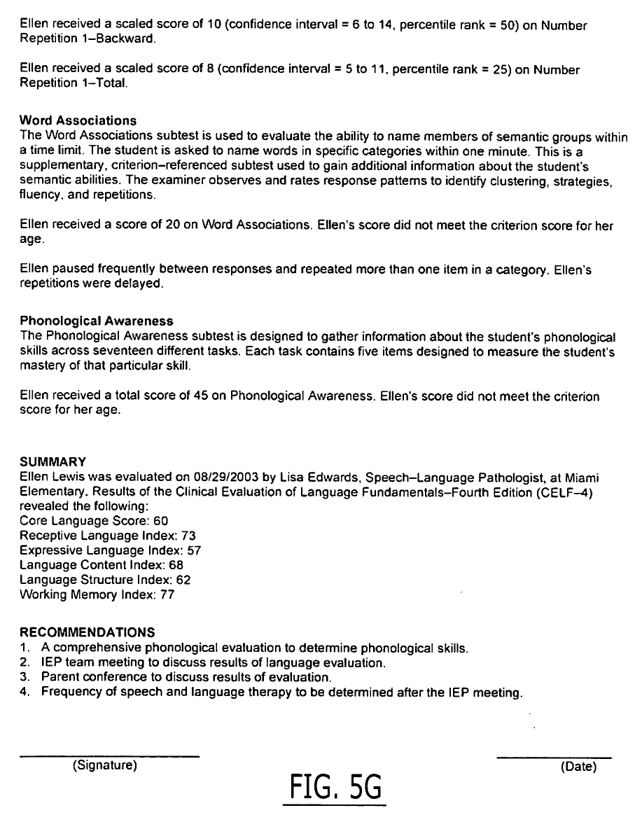

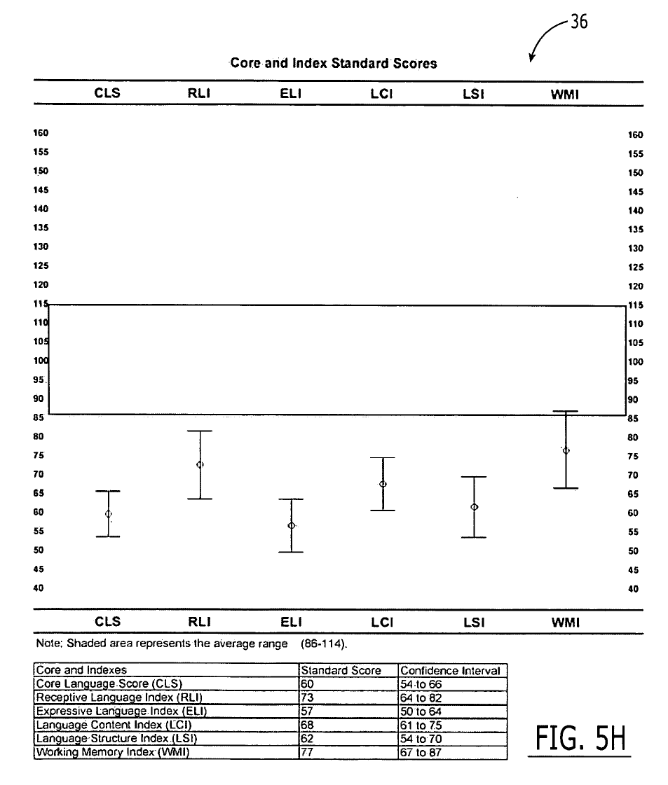

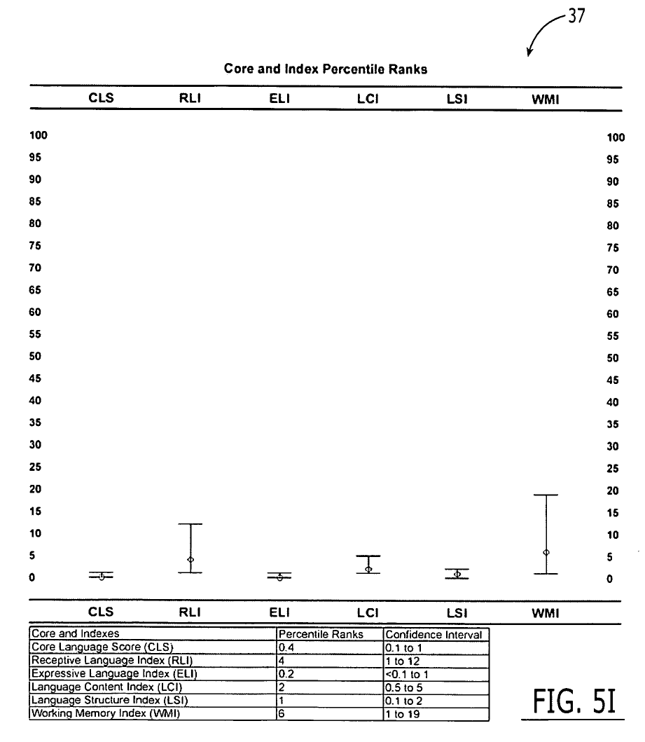

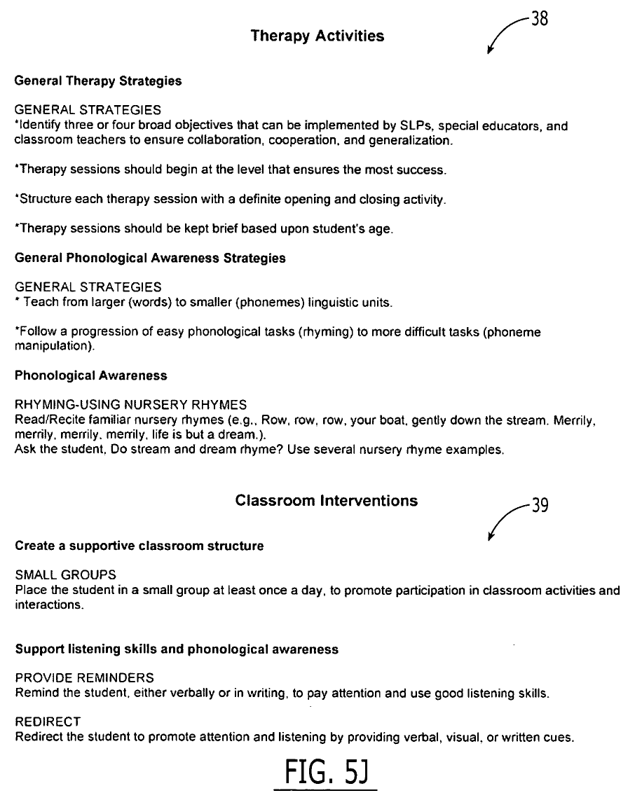

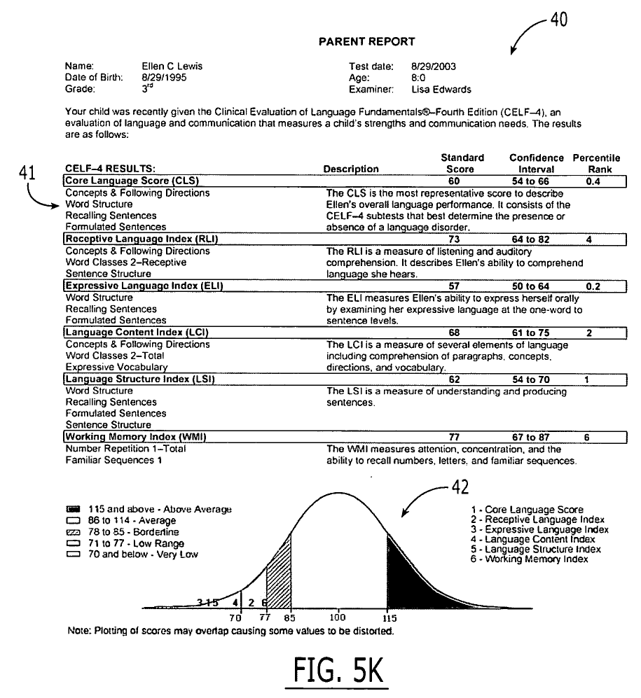

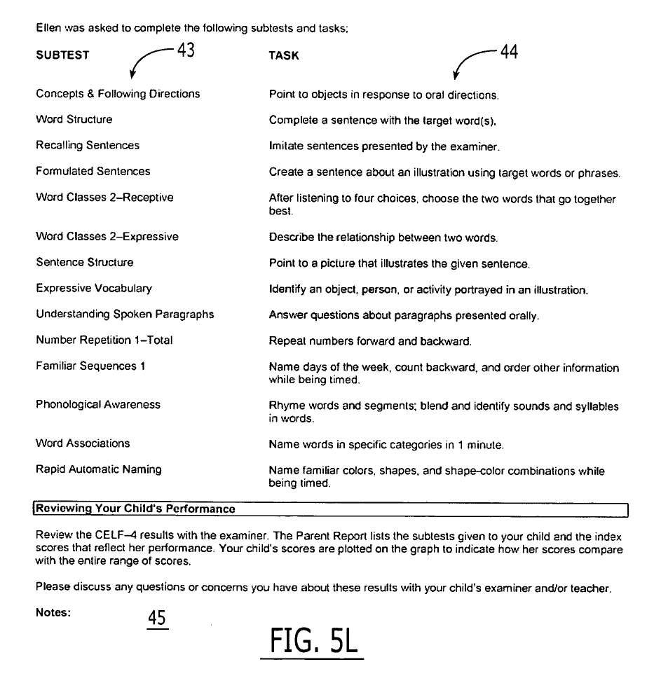

An exemplary computer-generated four-level summary report 20 is illustrated in FIGS. 5A-5L, wherein subtest and index scores 21 are provided for each level, as well as various statistics 22 relating the student's score to norms (FIGS. 5A and 5B). A narrative interpretive report 23 is also generated (FIGS. 5C-5G) for a plurality of indexes, including a core language score 24, receptive language index 25, expressive language index 26, a discrepancy analysis 27 between the receptive language index 25 and the expressive language index 26, a language content index 28, a language structure index 29, a discrepancy analysis 30 between the language content index 28 and the language structure index 29, and a working memory index 31.

Also provided are descriptions 32 of the subtest scores and verbiage 33 relating to the particular student's scores. A verbal summary 34 is also given, as well as recommendations 35 for follow-up testing, conferences, and therapy.

The software package also generates graphical presentations of the student's scores, including, for example, core and index standard scores 36 (FIG. 5H) and core and index percentile ranks 37 (FIG. 51). Recommendations for therapy activities 38 and classroom interventions 39 are provided (FIG. 5J).

A report 40 intended for the parents is also provided (FIGS. 5K and 5L), wherein the calculated indexes 41 are tabulated and discussed and placed on a graph 42 relative to the prevailing norms. The administered subtests 43 and tasks 44 are also tabulated, and space 45 is provided for additional notes.

In the foregoing description, certain terms have been used for brevity, clarity, and understanding, but no unnecessary limitations are to be implied therefrom beyond the requirements of the prior art, because such words are used for description purposes herein and are intended to be broadly construed. Moreover, the embodiments of the apparatus illustrated and described herein are by way of example, and the scope of the invention is not limited to the exact details of construction.

What is claimed is:

1. A method for assessing language skill in a subject comprising the steps of:
determining a presence of a language disorder;
if a language disorder is present, administering to the subject at least one of a plurality of subtests in any order, the subtests including assessments for determining a nature of the determined disorder, determining an underlying clinical behavior, and determining an effect caused by the disorder on a situational performance; and
based upon results of the one or more administered subtests, forming an evaluation of a language skill of the subject.

2. The method recited in claim 1, wherein the step of determining the language disorder presence comprises administering a plurality of subtests adapted to assess concepts and ability to follow directions, knowledge of word structure, ability to recall sentences, and ability to formulate sentences.

3. The method recited in claim 1, wherein the determined disorder nature determining step comprises administering at least one subtest from among a plurality of assessments, including assessments of expressive vocabulary and of word definitions.

4. The method recited in claim 1, wherein the underlying clinical behavior determining step comprises administering at least one subtest from among a plurality of assessments, including assessments of working memory, of an effect memory skills has on the language disorder, and of phonological awareness.

5. The method recited in claim 1, wherein the step of determining an effect caused by the disorder on situational performance includes formulating a pragmatics profile by eliciting input from at least one other person associated with the subject.

6. The method recited in claim 5, wherein the pragmatics profile formulating step comprises performing an evaluation of communication skills.

7. The method recited in claim 1, wherein the step of determining an effect caused by the disorder on situational performance includes administering a performance-based assessment of an ability of the subject to meet situational objectives.

8. The method recited in claim 1, wherein the evaluation forming step comprises calculating at least one of a core language score, a receptive language index, an expressive language index, a language content index, a language structure index, a language memory index, and a working memory index.

9. The method recited in claim 8, wherein the calculating step is performed automatically with the use of a software package using the results of the administered subtests.

10. The method recited in claim 9, further comprising the step of outputting a narrative and graphical report with the use of the software package based upon the results of the administered subtests and a database of normed data.

11. The method recited in claim 10, further comprising the step of outputting recommendations for at least one of therapy, further assessment, and intervention.

12. A language assessment comprising a plurality of subtests, each for evaluating a level of a language disorder, an administration of which is governed by a nonlinear process model, the subtests selected from among assessments for determining a presence of a language disorder, a nature of the determined disorder, an underlying clinical behavior, and an effect caused by the determined disorder on a situational performance.

13. The language assessment recited in claim 12, wherein the subtest for determining the language disorder presence comprises a plurality of subtests adapted to assess concepts and ability to follow directions, knowledge of word structure, ability to recall sentences, and ability to formulate sentences.

14. The language assessment recited in claim 12, wherein the determined disorder nature determining subtest comprises at least one of an expressive vocabulary and a word definitions subtest.

15. The language assessment recited in claim 12, wherein the underlying clinical behavior determining subtest comprises at least one of a working memory subtest, a subtest for assessing an effect memory skills has on the language disorder, and a phonological awareness subtest.

16. The language assessment recited in claim 12, wherein the subtest for determining an effect caused by the disorder on situational performance includes a subtest for formulating a pragmatics profile by eliciting input from at least one other person associated with the subject.

17. The language assessment recited in claim 16, wherein the pragmatics profile formulating subtest comprises an assessment for performing an evaluation of communication skills.

18. The language assessment recited in claim 12, wherein the subtest for determining an effect caused by the disorder on situational performance includes a performance-based assessment of an ability of the subject to meet situational objectives.

19. The language assessment recited in claim 12, further comprising means for forming an evaluation of the language skill of the subject, by calculating at least one of a core language score, a receptive language index, an expressive language index, a language content index, a language structure index, a language memory index, and a working memory index.

20. A system for assessing language comprising:
a plurality of subtests, each for evaluating a level of a language disorder, an administration of which is governed by a nonlinear process model, the subtests selected from among assessments for determining a presence of a language disorder, a nature of the determined disorder, an underlying clinical behavior, and an effect caused by the determined disorder on a situational performance;
means for administering to a subject at least one of the plurality of subtests in any order; and
a software package embodied on a computer-readable medium and installable on a processor, the software package adapted to receive results of the administered subtests and automatically output a narrative and graphical report based upon the input results.

21. The system recited in claim 20, wherein the subtest for determining the language disorder presence comprises a plurality of subtests adapted to assess concepts and ability to follow directions, knowledge of word structure, ability to recall sentences, and ability to formulate sentences.

22. The system recited in claim 20, wherein the determined disorder nature determining subtest comprises at least one of an expressive vocabulary and a word definitions subtest.

23. The system recited in claim 20, wherein the underlying clinical behavior determining subtest comprises at least one of a working memory subtest, a subtest for assessing an effect memory skills has on the language disorder, and a phonological awareness subtest.

24. The system recited in claim 20, wherein the subtest for determining an effect caused by the disorder on situational performance includes a subtest for formulating a pragmatics profile by eliciting input from at least one other person associated with the subject.

25. The system recited in claim 24, wherein the pragmatics profile formulating subtest comprises an assessment for performing an evaluation of communication skills.

26. The system recited in claim 20, wherein the subtest for determining an effect caused by the disorder on situational performance includes a performance-based assessment of an ability of the subject to meet situational objectives.

27. The system recited in claim 20, further comprising means for forming an evaluation of the language skill of the subject, by calculating at least one of a core language score, a receptive language index, an expressive language index, a language content index, a language structure index, a language memory index, and a working memory index.

28. The system recited in claim 20, wherein the software package is further adapted to output a narrative and graphical report with the use of the software package based upon the results of the administered subtests and a database of normed data.

29. The system recited in claim 28, wherein the software package is further adapted to output recommendations for at least one of therapy, further assessment, and intervention.
